(19) United States
(12) Patent Application Publication
(10) Pub. No.: US 2008/0120069 A1
(43) Pub. Date: May 22, 2008

(54) GENERATING AN ANALYTICAL MODEL OF BUILDING FOR USE IN THERMAL MODELING AND ENVIRONMENTAL ANALYSES

(76) Inventors: Jason Martin, Pembroke, NH (US); Thomas Hans Ingemar Olsson, Manchester, NH (US); Lev Minkovsky, Nashua, NH (US)

Correspondence Address: PATTERSON & SHERIDAN, L.L.P., 3040 POST OAK BOULEVARD, SUITE 1500, HOUSTON, TX, 77056, US

(21) Appl. No.: 11/740,534

(22) Filed: Apr. 26, 2007

Related U.S. Application Data
(60) Provisional application No. 60/866,940, filed on Nov. 22, 2006.

(51) Int. Cl. G06F 17/50

(52) U.S. Cl. 703/1

(57) ABSTRACT

Embodiments of the invention may be used to generate an analysis model of a building for use in thermal modeling and other analyses. A method for generating a model for use in determining environmental requirements includes the steps of receiving a computer-aided design (CAD) model of a building design, parsing the CAD model to identify one or more rooms in the building design, and generating a description for each of the one or more rooms. The description of a given room specifies a set of geometric properties describing the given room. The method also includes the steps of determining an environmental requirement of the building design based on the descriptions generated for the one or more rooms and storing the results of the analysis and the determined environmental requirement for review.

### CROSS REFERENCE TO RELATED APPLICATIONS

This application claims the benefit under 35 U.S.C. § 119(e) to U.S. Provisional Application Ser. No. 60/866,940, filed on Nov. 22, 2006, incorporated by reference herein in its entirety.

### BACKGROUND OF THE INVENTION

1. Field of the Invention

The present invention generally relates to computer software. More specifically, the present invention relates to techniques for calculating an analytical model of a building used in thermal modeling and analysis.

2. Description of the Related Art

The architectural design of buildings is commonly performed with computer-aided design (CAD) software applications. Users of CAD applications can design buildings by constructing computer models of the buildings, which includes specifications of construction, dimensions, materials, windows, doors, and the like. However, CAD applications are typically not configured to determine the heating, ventilation, and air conditioning (HVAC) requirements (“loads”) of a building. Instead, the HVAC loads are usually analyzed by using specialized software programs, referred to herein as HVAC analysis tools.

Typically, an HVAC analysis tool is used to construct an HVAC analysis model of a building. An HVAC analysis model enables the HVAC requirements of the building to be analyzed. An HVAC analysis model requires data on the characteristics of the building, such as the dimensions of the rooms of the building, the materials and layout of the rooms, the number of occupants, the heat generated by electrical devices, the climate conditions at the building location, the solar energy absorbed by the building, and the like.

Conventionally, an engineer creates an HVAC analysis model by manually loading the model with data taken from a CAD building design. For example, an engineer may print a copy of the CAD building design, measure the appropriate plan dimensions with a ruler (or using tools provided by the CAD application), determine the associated room height, and then input each dimension into the HVAC analysis model. Such manual measurements are time-consuming and tedious. Thus, the manual process of loading an HVAC analysis model is usually only performed twice, at the beginning and end of the CAD building design process. However, it is common that a building design can change significantly during the design process. If an HVAC analysis model is not updated to match a changed building design as it changes, the HVAC analysis model will likely be inaccurate and result in costly mistakes.

Further, manually measuring print-outs results in an HVAC analysis model that is, at best, an approximation that is likely to contain errors. For example, an engineer may build an HVAC analysis model using centerline wall dimensions (i.e., a point halfway through the thickness of the wall) instead of using the interior room dimensions (i.e., from the inner surfaces of each wall). The interior room dimensions are important for certain HVAC load calculations, such as determining the heat transfer characteristics of the system and the air flow requirements. Thus, the use of centerline wall dimensions alone can lead to significant errors in the HVAC analysis.

The limitations of manual measurements are magnified by the presence of irregular walls or ceiling topology in the building design. Similarly, manual measurements may fail to account for shading of sun light by surfaces external to the room (e.g., roof overhangs). These aspects of a building design are sometimes ignored due to the effort required to include them in the HVAC analysis model.

The above-described problems associated with creating HVAC analysis models also occur when analyzing other environmental aspects of a building design. For example, the lighting requirements of a building (i.e., the number of light fixtures, fixture locations, wattage, etc.) may be determined by using a lighting analysis model. However, a lighting analysis model requires many of the same data inputs as an HVAC analysis model. Thus, the process of generating a model from a CAD building design for performing a lighting analysis suffers from many of the same difficulties described above.

As the foregoing illustrates, there is a need in the art for techniques for generating a computational model of a building design for use in thermal modeling analyses or other facility requirements analyses.

### SUMMARY OF THE INVENTION

One embodiment of the invention includes a method for generating a model for use in determining environmental requirements. For example, embodiments of the invention may be used to generate a model of a building for use in thermal modeling and other analyses. A method for generating an analytical model of a building for use in environmental requirements includes the steps of receiving a computer-aided design (CAD) model of a building design, parsing the CAD model to identify one or more rooms in the building design, and generating a description for each of the one or more rooms. The description of a given room specifies a set of geometric properties describing the given room. The method also includes the steps of determining an environmental requirement of the building design based on the descriptions generated for the one or more rooms and storing the results of the analysis and the determined environmental requirement for review.

In a particular embodiment, generating a description of the given room may include computing an interior volume measurement of a region of space enclosed by the walls, ceiling, and floor of the given room. Similarly, generating a description of the given room may include computing an analytical volume measurement of the given room specifying an intra-wall space between the given room and an adjacent room in the building design.

Another embodiment of the invention includes a computer readable medium storing instructions for generating an analytical model of a building for use in environmental requirements modeling, including instructions for performing the steps of the recited method.

Advantageously, embodiments of the invention may be used to generate analysis model of a building for use in thermal modeling and analysis directly from the drawing elements included in a CAD drawing representing the building design. Thus such an analysis may be performed at any phase of the building design process. Further, the thermal model may accurately reflect a variety of features of the building design typically omitted from a manual or ad-hoc requirements analysis.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system for calculating the analysis model of a building for use in thermal modeling and analysis, according to one embodiment of the invention.

FIGS. 2A-2D illustrate aspects of an analysis model of an example room, according to one embodiment of the invention.

FIGS. 3A-3B illustrate an screen of an HVAC analysis user interface, according to one embodiment of the invention.

FIG. 4 illustrates a method for calculating the analysis model of a building for use in thermal modeling and analysis, according to one embodiment of the invention.

### DETAILED DESCRIPTION

Embodiments of the invention provide techniques for generating a thermal analysis model for a building. In one embodiment, a computer-aided design (CAD) model is used to generate an analysis model for determining the heating, ventilation, and air conditioning (HVAC) requirements of a given building design. Additionally, the CAD model may also be used to generate an analysis model for determining the lighting requirements, or other environmental features, for the building.

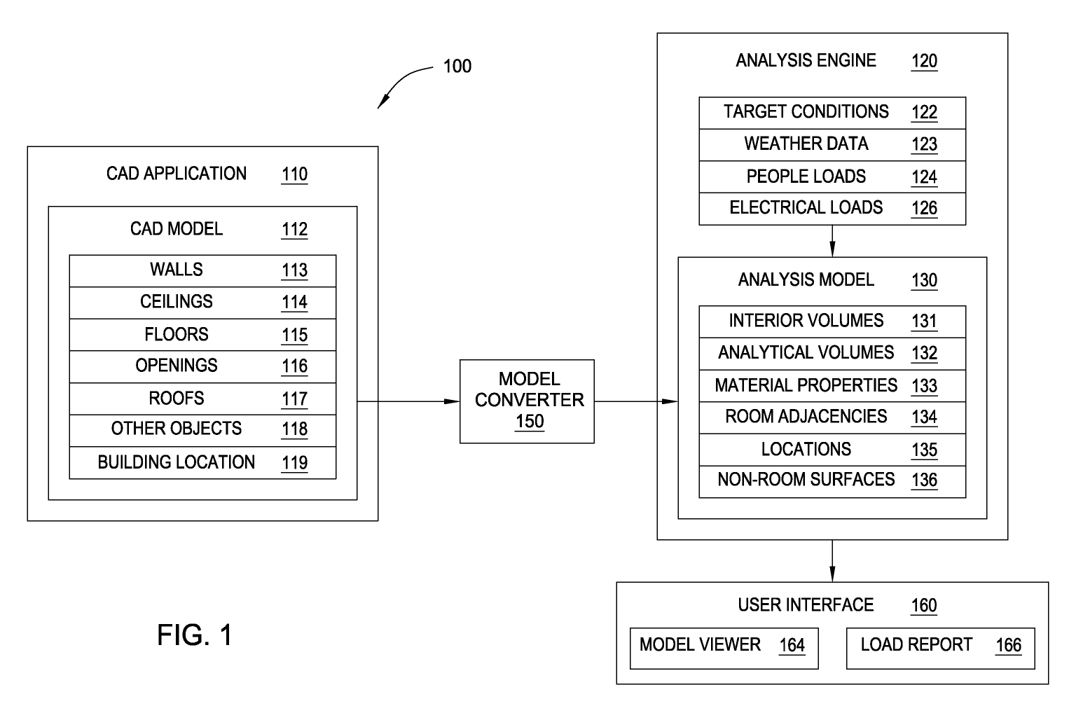

FIG. 1 is a block diagram illustrating a computer system 100 for generating a computational model of a building for use in thermal analysis, according to one embodiment of the invention. Note, the components illustrated in system 100 are included to be representative of computer software applications executing on existing computer systems, e.g., desktop computers, server computers, laptop computers, tablet computers, and the like. The software applications described herein, however, are not limited to any particular computing system and may be adapted to take advantage of new computing systems as they become available.

Additionally, the components illustrated in system 100 may be implemented as software applications that execute on a single computer system or on distributed systems communicating over computer networks such as local area networks or large, wide area networks, such as the Internet. For example, system 100 may include a software program executing on a client computer system at one physical location communicating with a computer-aided design (CAD) application 110 at another physical location. Also, in one embodiment, a CAD application 110 and an analysis engine 120 may be provided as an application program (or programs) stored on computer readable media such as a CD-ROM, DVD-ROM, flash memory module, or other tangible storage media.

As shown, the system 100 includes, without limitation, a CAD application 110, an analysis engine 120, a model converter 150, and a user interface 160. The CAD application 110 includes a CAD model 112, which includes data objects for walls 113, openings 116, roofs 117, other objects 118, and a building location object 119.

In one embodiment, the CAD model 112 may provide a representation of a building design. A user generates the building design of CAD model 112 by designing the overall structure of the building, as well as designing one or more rooms that are part of the building. Typically, the room designs are constructed by specifying drawing elements to model components of the building, such as the walls 113, ceilings 114, and floors 115 of the rooms. In addition, a room design may include drawing elements to model room openings 116, such as windows and doors. The structure of the building may be modeled by adding drawing elements for roofs 117 and other objects 118 to the CAD model 112. Each drawing element of the CAD model 112 may specify a position, relative to the other elements in the CAD model 112 and to the building site. In some cases, the drawing elements of the CAD model 112 may specify the materials used to construct the corresponding component of the building. For example, a wall 113 may be modeled using drawing elements representing frame members composed from 2×4 studs covered with dry wall. In such case, CAD model 112 may also include elements representing items such as insulation, electrical wiring, and wall receptacles for plugs and light switches. A building location data object 119 may specify the orientation (i.e., north, south, etc.) and geographic location (i.e., latitude and longitude) of the building design. This information may be used in a thermal modeling to simulate the expected temperatures and sunlight exposure the building is likely to experience at the given geographic location and position.

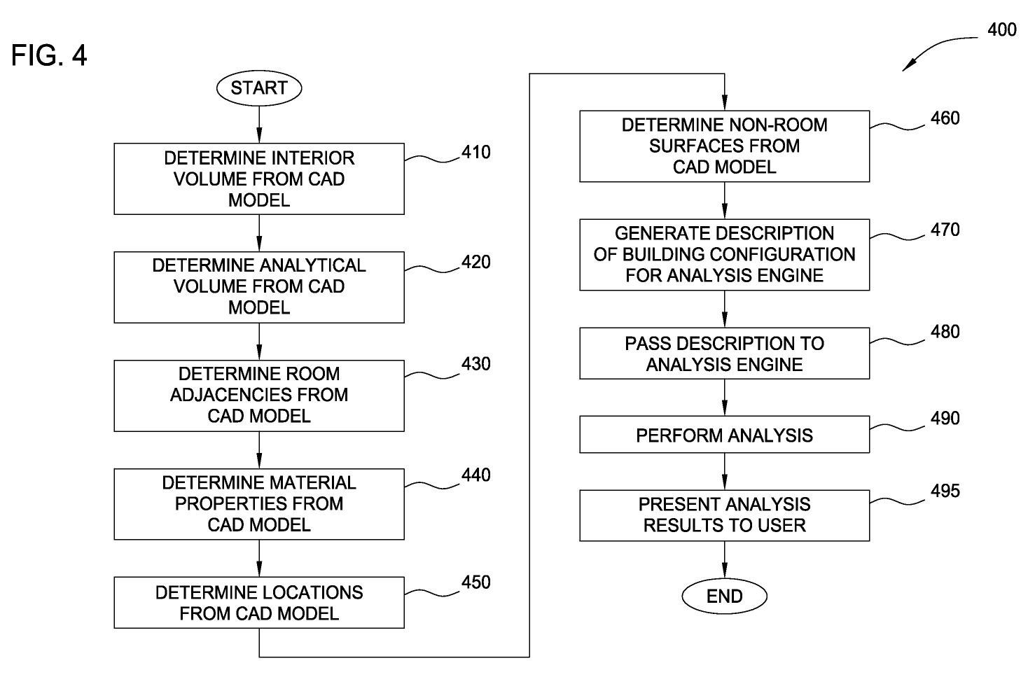

In one embodiment, a model converter 150 may be configured to process the data objects of the CAD model 112 to generate an analysis model 130. Although shown separately from CAD application 110, model converter 150 may be integrated with CAD application 110. In any case, model converter 150 may be configured to parse a given CAD model 112, e.g., parse the data objects and/or drawing elements representing walls 113, ceilings 114, floor 115, openings 116, roofs 117, and other objects 118 to generate model 130. The model 130 may provide a representation of the building design in CAD model 112 suitable for processing by an analysis engine 120. In one embodiment, the model 130 may be composed according to existing building model standard or description language. For example, the publicly available gbXML format may be used. Model converter 150 is described further below with reference to FIG. 4.

Analysis engine 120 may be configured to perform HVAC load calculations. The HVAC load calculations may be based on a set of target conditions 122, such as weather data 123, people loads 124, electrical loads 126, and analysis model 130. As shown, analysis 130 includes interior volume measurements 131, analytical volume measurements 132, material properties measurements 133, room adjacencies data objects 134, location data objects 135, and non-room surface data objects 136. In one embodiment, the measurements and data objects used by analysis engine 120 may be generated by model converter 150 from CAD model 112. By providing multiple volume measurements, the analysis engine 120 may be used to calculate a sophisticated thermal model of a building design using the interior volume measurements 131 when appropriate and using the analytical volume measurements 132 when appropriate. Of course, the invention is not limited to these two types of volume measurements or any particular mode of thermal analysis and other data may be generated by a particular model converter 150 for use by analysis engine 120.

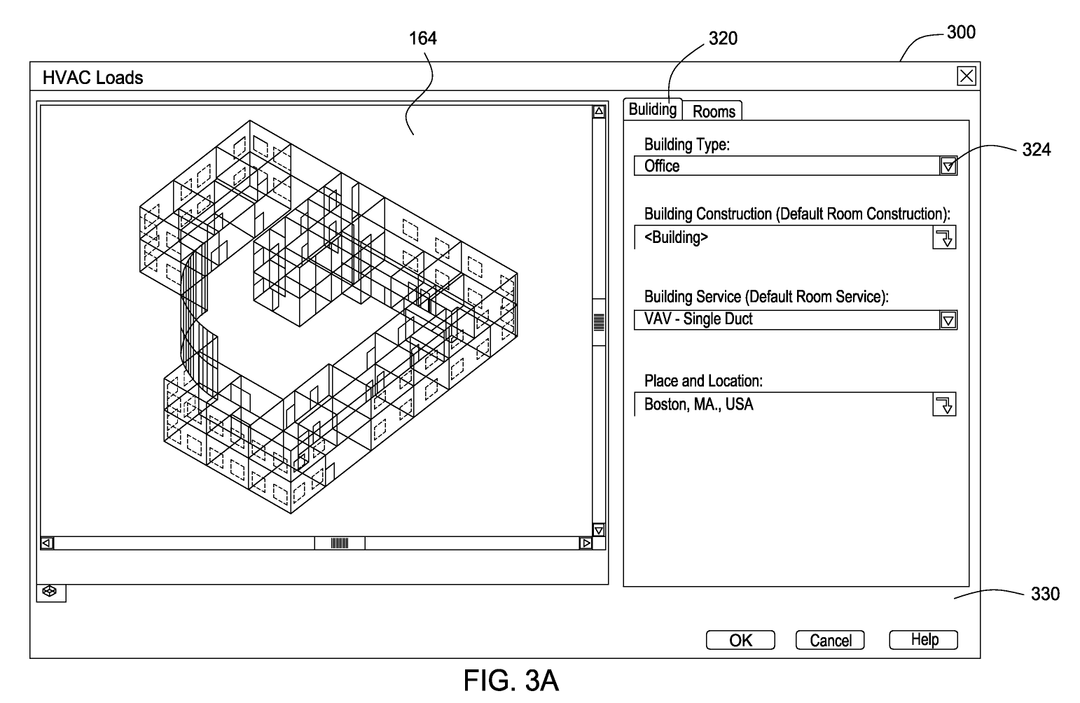

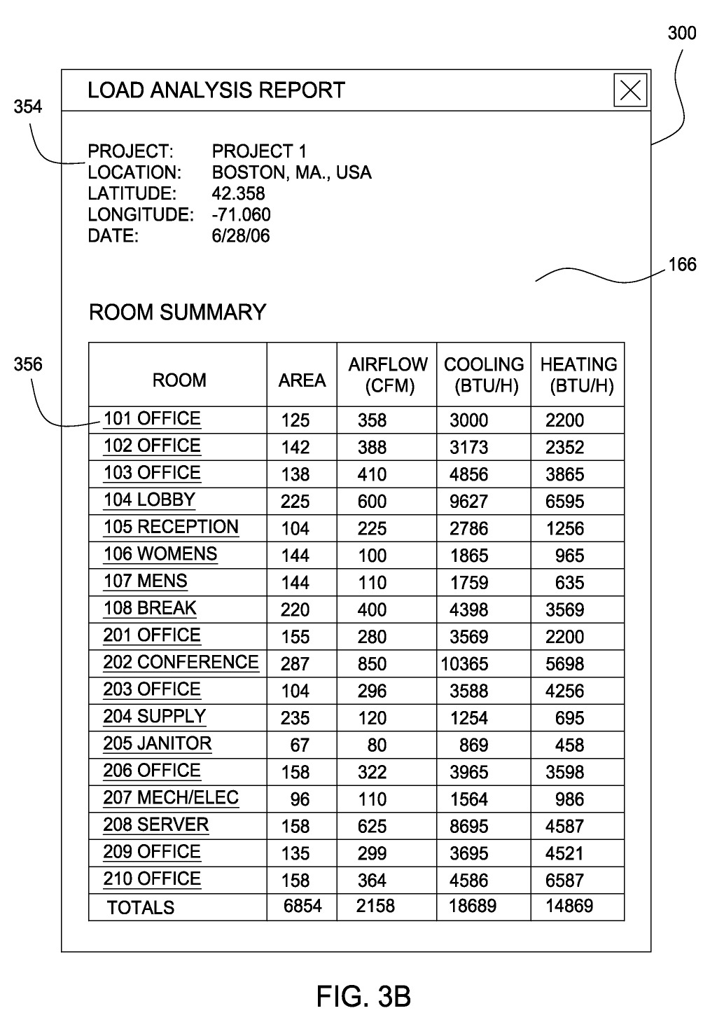

User interface 160 may include any combination of graphical elements such as windows, menus buttons, ribbons, dialog boxes, etc., used to invoke the features and functions of CAD application 110 and analysis engine 120. Illustratively, user interface 160 includes a model viewer 164 and a load report 166. The model viewer 164 may be configured to provide a user with a graphical representation of the analysis model 130 generated by the model converter 150. After the analysis engine 120 completes the HVAC analysis, the results may be presented to a user in a load report 166. FIGS. 3A-3B, referenced below, illustrate an example user interface 160 and load report 166.

In one embodiment, the analysis engine 120 may, in part, perform HVAC load calculations for a building by determining the amount of heat transfer (i.e., heat gain or loss) from the building to the surrounding environment. HVAC load calculations may require determining the amount of heat transfer from one room to others or to the environment external to the building. As is known, the amount of heat transfer for a room depends on how well insulated the room is from its surroundings, the volume and shape of the room, the amount of sunlight/shade provided by windows, etc. The amount of heat transfer also depends on factors such as the dimensions, geometry, and materials of the boundaries of the room (i.e., walls, floor, and ceiling) as well as the temperatures involved. In addition to calculating heat transfer, analysis engine 120 may also determine what HVAC loads are needed to maintain a particular environmental state.

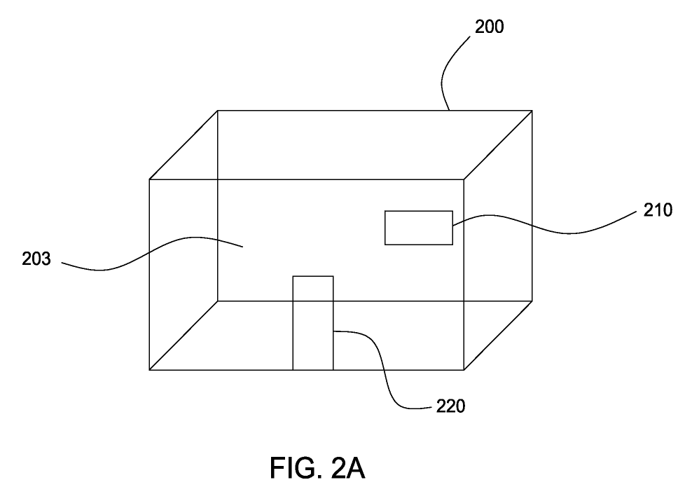

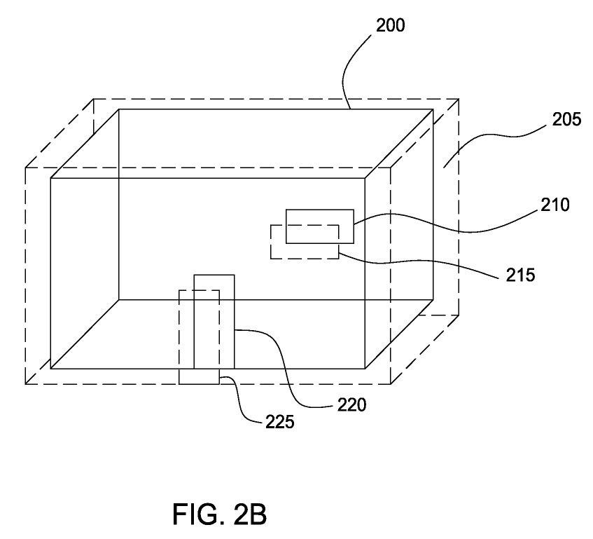

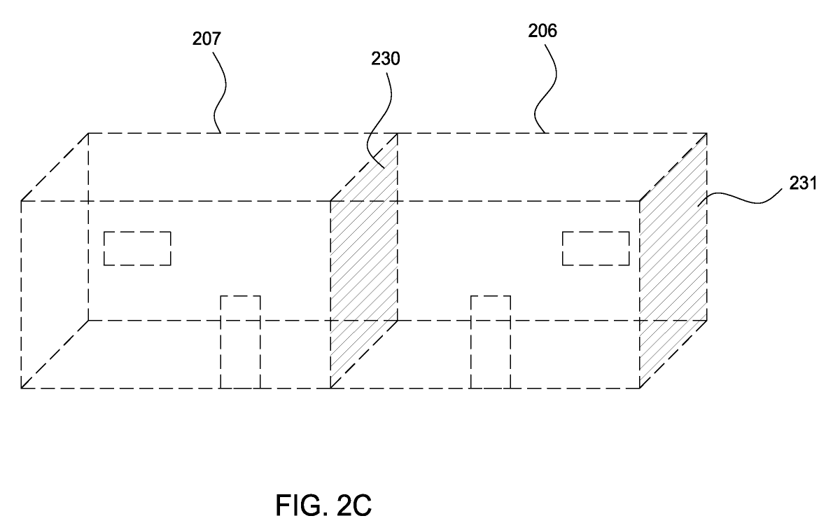

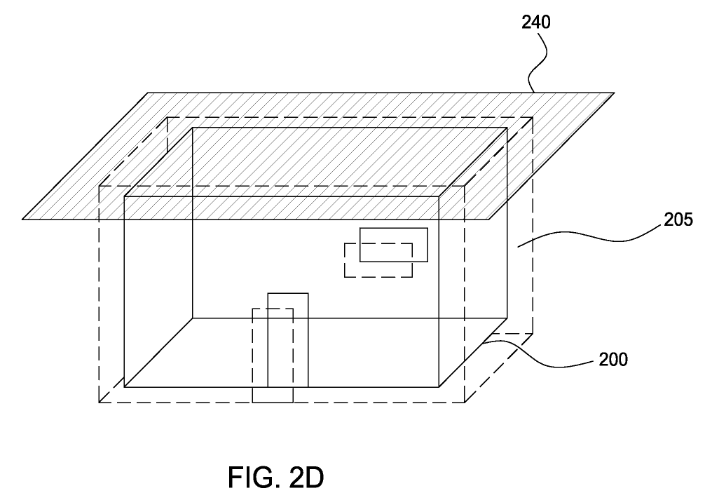

The volumes and room measurements may be calculated analyzing the CAD model 112. In one embodiment, the interior volume measurements 131 and the analysis volume measurements 132 are used to calculate the heat transfer between rooms included in a given building design. The interior volume measurements 131 represent the dimensions and geometry of the interior volumes of rooms in the building, including openings such as doors or windows. The model converter 150 may be configured to determine interior volume measurements for a given room based on the positions of drawing elements representing inner surfaces of the walls, floors, and ceilings within CAD model 112. FIG. 2A illustrates an example of an interior volume 203 of a room 200. As shown, room 200 includes a window opening 210 and a door opening 220. The interior volume 203 represents a region of space enclosed by the walls, ceiling and floor of room 200.

The analysis volume measurements 132 represent dimensions and geometry of the room volumes at the centerline wall dimensions of the walls, floor, and ceilings. Thus, the analysis volume measurements 132 account for the intra-wall spaces between two rooms. This may include both interior-interior wall spaces, as well as interior-exterior wall spaces. In one embodiment, the centerline dimensions may be measured from a point halfway through the thickness of the walls, floor, and ceilings. FIG. 2B illustrates an example of an analysis volume 205 of room 200. As shown, analysis volume 205 is based on the centerline dimensions of the room and is slightly larger than the interior volume 203 of room 200. Analysis volume measurements 205 also include a window opening 215 and a door opening 225 that correspond to the openings in interior volume 203 of room 200.

As stated, heat transfer calculations may be preformed using the thermal properties of room boundaries. The thermal properties may specify, for instance, how well insulated a room is from heat transfer. For example, a model of a wall constructed of steel beams and cement board of a certain thickness possess a thermal conductance, commonly referred to as a “U” value. In one embodiment, the “U” value, or other thermal properties data, may be stored in the material properties data objects 133. Additionally, heat transfer calculations are preformed using data regarding the temperature differences between the interior and exterior of the walls, floors, ceilings, and openings of the rooms. Accordingly, the data used by analysis engine 120 includes the target conditions 122, which may specify the desired temperatures inside a room, as well as the desired humidity and airflow values. For instance, the desired temperature inside a room in an office building is commonly set to 72 degrees Fahrenheit.

Further, the exterior conditions such as expected sunlight and average temperate for a given location affect the HVAC calculations for a given building model. In the case of a heat transfer analysis of a wall (or other boundary) that is part of the exterior of the building, the temperature outside the room is the ambient temperature around the building. In one embodiment, the ambient temperature may be derived from weather data 123 and from the geographic location specified for the building. The location of the building may be provided as part of location data objects 135 included in the analysis model 130. The weather data 123 is based on historical measurements, and may specify expected values for ambient temperature, humidity, and sunlight for various times of the year and at various geographic locations (e.g., for a given longitude and latitude.) Thus, the target conditions 122 and the weather data 123 provide the temperature differences between the interior of a room and the exterior of a building, as required for some heat transfer calculations.

However, some walls or other boundaries of a room may not be external, and may also be a boundary of an adjacent room of the building. In one embodiment, such shared boundaries are specified in the room adjacencies data objects 134 included in the analysis model 130. FIG. 2C illustrates an example of a first analysis volume 206 and a second analysis volume 207 of two adjacent rooms. As shown, the volumes 206 and 207 represent the volumes of two adjacent rooms sharing a common wall 230. In this example, the temperature difference across the common wall 230 is generally expected to be less than the temperature difference across an external wall 231. That is, the temperature difference between the two analysis volumes 206 and 207 is typically less than the temperature difference between the interior of the analysis volume 206 and the exterior of the building.

Other inputs that may be used in performing heat transfer calculations include the amounts of heat generated by sources other than the HVAC facilities of the building. The heat sources that are internal to the building are usually specified in the people loads 124 and the electrical loads 125 of the analysis engine 120. The people loads 124 estimate the heat created by the bodies of the occupants. The electrical loads 125 estimate the heat created by electrical devices inside the building, such as electric lights, refrigerators, computers, etc.

One common source of heat includes sunlight shining directly on the building. The amount of heat gained from sunlight at the building location may be derived from the weather data 123 and the location data objects 135. However, if there are any sources of shade from sunlight covering a portion of the building, the amount of heat gain from sunlight is likely to be reduced. Thus, in one embodiment, the analysis model 130 includes data objects for non-room surfaces 136. These data objects represent components of the building structure that are not part of specific rooms, but which may impact the thermal analysis of the building design. FIG. 2D illustrates an exemplary non-room surface 240. In this example, the non-room surface 240 is an overhanging roof that extends over the analysis volume 205 of room 200. In some situations, the non-room surface 240 may shade the walls of the room from sunlight, and thus reduce the amount of heat gained by the room.

FIGS. 3A-3B illustrate an exemplary screen 300 of a user interface (e.g. user interface 160 of FIG. 1) 160, according to one embodiment of the invention. As shown in FIG. 3A, the screen 300 includes a model viewer 164, property tabs 320, and control buttons 330. Illustratively, model viewer 164 displays a graphic representation of an analysis model 130. As part of the building property tab, the user is provided with a set of property selection controls 324, which may be used to set specific properties of the analysis model 130 prior to running an HVAC analysis. In this example, the selection controls 324 allow a user to specify a building type, a building construction, a building service (i.e., the type of HVAC systems available), and the location of the building to use in a thermal analysis. Of course, the selection controls 324 provided by user interface 160 may be tailored depending on the type of thermal (or other analysis) to be performed. Control buttons 330 allow the user to select interface commands, such as running the HVAC analysis.

FIG. 3B illustrates a screen 300 displaying an exemplary load report 166 generated from CAD model 112. Illustratively, load report 166 summarizes the results of the HVAC analysis of the analysis model 130 shown in FIG. 3A. As shown, load report 166 includes a project header 354, which includes the project name, location, and date. The load report 166 also includes summary data for each room on the first and second floor of a building design, as well as the load totals for the building. For example, a first report line 356 describes the analysis results for the room “101 Office.” As shown, the analysis of room “101 Office” results in an airflow load of 358 cubic feet per minute (CFM,) a cooling load of 3000 British Thermal Units per hour (BTU/h,) and a heating load of 2200 BTU/h. Similar data is available for the other rooms of this building design.

FIG. 4 illustrates a method 400 for calculating the analysis model 130 of a building for use in thermal modeling and analysis, according to one embodiment of the invention. The method 400 may be carried out by model converter 150 configured to generate analysis model 130 from CAD model 112. However, persons skilled in the art will understand that any system configured to perform the steps of method 400, in any order, is within the scope of the present invention.

The method 400 begins at step 410 where interior volumes of the rooms included in a given building design are determined from a CAD model, such as CAD model 112. For example, model converter 150 may determine interior room volume 203 of the room 200 shown in FIG. 2A. At step 420, the analytical volumes of the rooms included in the given building design are determined. For example, model converter 150 may determine the analytical room volume 205 of the room 200 shown in FIG. 2B. At step 430, the adjacencies of the room are determined from the CAD model. For example, model converter 150 may determine the adjacency 230 between rooms 206 and 207 shown in FIG. 2C. At step 440, the material properties of the elements (e.g., walls, ceiling, floor, openings) of the room are determined from the CAD model. In one embodiment, the drawing elements, e.g., data objects and/or drawing elements representing walls 113, ceilings 114, floor, 115, openings 116, roofs 117, and other objects 118 in CAD model 112 serve as the drawing elements. At step 450, the locations of the rooms are determined from the CAD model. That is, the geographic locations to use in performing a thermal analysis are determined. At step 460, non-room surfaces that are part of the building are determined from CAD model 112. For example, the roof surface 240 of room 200 shown in FIG. 2D constitutes such a non-room surface.

Once the CAD properties and elements of a building design represented by the CAD model are determined (steps 410-460), then at step 470, a description of the building configuration is generated for an analysis engine 120. Any thermal (or other) analysis engine may be used, e.g., the IES <Virtual Environment> building analysis tool available from Integrated Environment Solutions. At step 480, the description of the building configuration generated from the CAD model is passed to the analysis engine 120. At step 490, a thermal analysis (or other analysis) is performed based on the generated description. At step 495, the analysis results are presented to the user. For example, the analysis engine may be configured to generate and render a display similar to the load report 166 of FIG. 3B.

Advantageously, embodiments of the invention may be used to generate a thermal model of a building design represented by a CAD model. Such an analysis may be performed at any phase of the building design process. Further, the thermal model may accurately reflect a variety of features of the building design typically omitted from a manual or ad-hoc requirements analysis. As described, the embodiments of the invention may be used to generate a model used as input for a thermal or other analysis, of a building. The model generally describes features of the building relevant for a given analysis. For example, for a thermal analysis, the model may describe the rooms, the room size, the thermal characteristics (e.g., insulation “U” values), and the geographic location of a building design.

Further, embodiments of the invention may be used to generate models for other types of environmental analyses of a building design. For example, the lighting requirements of a building or the safety equipment requirements of a building may be analyzed using the teaching of the present invention as set forth herein. When analyzing lighting requirements, the location, shading, and shape and structure of the rooms in a building may be analyzed to determine what natural lighting levels may be expected based on the location, position, and number of windows, sunlight or other openings in the building. Similarly, such an analysis may specify what artificial lighting requirements are necessary to achieve a desired lighting level.

While the forgoing is directed to embodiments of the present invention, other and further embodiments of the invention may be devised without departing from the basic scope thereof, and the scope thereof is determined by the claims that follow.

What is claimed is:

1. A method for generating a model for use in determining environmental requirements, comprising:
receiving a computer-aided design (CAD) model of a building design;
parsing the CAD model to identify one or more rooms in the building design;
generating a description for each of the one or more rooms, wherein the description of a given room specifies a set of geometric properties describing the given room;
determining an environmental requirement of the building design based on the descriptions generated for the one or more rooms; and
storing the results of the analysis and the determined environmental requirement for review.

2. The method of claim 1, wherein generating a description of the given room comprises computing an interior volume measurement of a region of space enclosed by the walls, ceiling, and floor of the given room.

3. The method of claim 1, wherein generating a description of the given room comprises computing an analytical volume measurement of the given room specifying an intra-wall space between the given room and an adjacent room in the building design.

4. The method of claim 3, wherein the description of the given room further specifies a thermal “U” value for a design material specified for use in constructing the given room.

5. The method of claim 1, wherein determining an environmental requirement of the building design comprises performing a thermal analysis of the building design to estimate a heating ventilation and air conditioning (HVAC) load requirement for the one or more rooms.

6. The method of claim 5, wherein the thermal analysis accounts for a geographic location of the building design and historical weather data based on the geographical location.

7. The method of claim 1, wherein determining an environmental requirement of the building design comprises performing a lighting analysis of the building design to estimate a lighting requirement for the one or more rooms.

8. A computer-readable medium storing instructions for generating a model for use in determining environmental requirements, including instructions for performing the steps of:
receiving a computer-aided design (CAD) model of a building design;
parsing the CAD model to identify one or more rooms in the building design;
generating a description for each of the one or more rooms, wherein the description of a given room specifies a set of geometric properties describing the given room;
determining an environmental requirement of the building design based on the descriptions generated for the one or more rooms; and
storing the results of the analysis and the determined environmental requirement for review.

9. The computer-readable medium of claim 8, wherein generating a description of the given room comprises computing an interior volume measurement of a region of space enclosed by the walls, ceiling, and floor of the given room.

10. The computer-readable medium of claim 8, wherein generating a description of the given room comprises computing an analytical volume measurement of the given room specifying an intra-wall space between the given room and an adjacent room in the building design.

11. The computer-readable medium of claim 10, wherein the description of the given room further specifies a thermal “U” value for a design material specified for use in constructing the given room.

12. The computer-readable medium of claim 8, wherein determining an environmental requirement of the building design comprises performing a thermal analysis of the building design to estimate a heating ventilation and air conditioning (HVAC) load requirement for the one or more rooms.

13. The computer-readable medium of claim 12, wherein the thermal analysis accounts for a geographic location of the building design and historical weather data based on the geographical location.

14. The computer-readable medium of claim 8, wherein determining an environmental requirement of the building design comprises performing a lighting analysis of the building design to estimate a lighting requirement for the one or more rooms.

15. A method for generating a model for use in determining environmental requirements, comprising:
specifying a selection of a CAD model of a building design;
specifying an environmental requirement of the building design to determine from the analysis; and
invoking a model converter tool configured to:
parse the CAD model to identify one or more rooms in the building design;
compute a description of the rooms, wherein the description of a given room specifies a set of geometric properties describing the given room;
perform an analysis based on the description, wherein the analysis determines an environmental requirement of the one or more rooms; and
store the results of the analysis and the determined environmental requirement for review.

16. The method of claim 15, wherein the geometric properties specify an interior volume measurement of a region of space enclosed by the walls, ceiling, and floor of the given room.

17. The method of claim 15, wherein the geometric properties specify an analytical volume measurement of the given room that includes a measurement of an intra-wall space between the given room and an adjacent room in the building design.

18. The method of claim 17, wherein the description of the given room further specifies a thermal “U” value for a design material specified for use in constructing the given room.

19. The method of claim 15, wherein the analysis is a thermal analysis of the building design configured to estimate a heating ventilation and air conditioning (HVAC) load requirement for the one or more rooms.

20. The method of claim 19, wherein the thermal analysis accounts for a geographic location of the building design and historical weather data based on the geographical location.

21. The method of claim 15, wherein the environmental requirement comprises a lighting analysis of the building design, wherein the lighting analysis of the building design estimates a lighting requirement for the one or more rooms.
